(19) United States
(12) Patent Application Publication
(10) Pub. No.: US 2016/0225226 A1
(43) Pub. Date: Aug. 4, 2016

(54) Method and System of Playing Game through Communication Tool

(71) Applicant: Jesus Pereo-OcHoa, Montebello, CA (US)

(72) Inventor: Jesus Pereo-OcHoa, Montebello, CA (US)

(21) Appl. No.: 15/096,238

(22) Filed: Apr. 11, 2016

Related U.S. Application Data
(63) Continuation-in-part of application No. 12/924,651, filed on Sep. 30, 2010.

(51) Int. Cl. G07F 17/32; H04W 12/06

(52) U.S. Cl. CPC G07F 17/3241; H04W 12/06; G07F 17/3225

(57) ABSTRACT

A method of communicatively linking a plurality of electronic devices via users includes the steps of remotely linking the electronic devices in a closed communication network from a facility; verifying each user for the electronic device in an authorized manner in order to activate the electronic device by connecting a user smart phone of the user to the electronic device; restricting each user to remotely access the electronic device in limited locations within an area of the facility via a GPS unit built-in with the electronic device and within a range of the closed communication network; and connecting the electronic devices with each other through the closed networking system that allows the user to selectively communicate with each other and to selectively execute different applications preloaded in the electronic device through the closed communication network in a real time manner.

### CROSS REFERENCE OF RELATED APPLICATION

This is a Continuation-In-Part application that claims priority to U.S. non-provisional application, application number Ser. No. 12/924,651, filed Sep. 30, 2010, the entire contents of each of which are expressly incorporated herein by reference.

### BACKGROUND OF THE PRESENT INVENTION

1. Field of Invention

The present invention relates to a method of playing games, and more particularly to method and system for playing game, such as a card game, between two or more people through a communication tool in a real time manner.

2. Description of Related Arts

The games, such as casino or gambling games, are dramatically popular for entertainment people nowadays. The games usually have the basic rules, so that the players play the game with the strategies based on the rules. Some of the gambling type games are designed for people betting against each other, such as poker; the other games are designed for the player wagering against the dealer.

The games in casino generally being played by the following two methods. One of the main types of gambling games is the table games. These types of games usually require one or more players physically gather together on a specific designed gambling table, wherein there may have at least one dealer for host the gambling game, so that the players are able to wager against the house. On the other hands, the players may also gather together at the gambling table for playing against each other, such as Texas Hold'em poker game, and one of the players can be the dealer of the game when he or she meets the agreed requirements. However, during the peak gambling time in the casino, all the tables of the table games may be crowded and full of players, so that it is hard to get a spot for playing the game. The player may have to wait in line in order to play. It is time consuming and tiring for the gamblers.

In addition, most casinos require a certain dress code policy that delineates what should be the acceptable and appropriate standard of dress and personal appearance of the players. For example, the player may not be able to wear pajama to play the table game when he or she stays in the hotel room. Therefore, he or she may not want to leave the hotel room at all. Disable people or seniors may not able to travel long distance in order to play the table game. Furthermore, privacy is also limited some high profiled clients who will stay away from the game.

The other main types of the games in casino are the machine type games, such as electronic gaming machines, which may include slot machine or roulette. Take the roulette for example, the display panel of the machine may have a virtual roulette spinning wheel, wherein after the player betting on the desired numbers, colors, or odd or even of the numbers, the player can push a bottom to spin the virtual wheel to randomly generate the numbers, so as to determined the winning or losing of the player. In general, the player is wagering against the machine when he or she chooses to play the machine type games. Therefore, the virtual games of the gambling machines are unable to provide the gamblers the fun of betting or playing against other real players. In other words, this type of game is limited to the chatting among players. There is no communication and interaction, sociability among players.

Thereby, the current methods for playing games, especially for gambling games in casino, are limited, so that the gamblers or players have not much chooses.

### SUMMARY OF THE PRESENT INVENTION

The invention is advantageous in that it provides a method and system of playing games through a communication network. Therefore, the player will have a choice of staying in the hotel room, lying at the pool side area, or while lounging to play the game.

Another advantage of the present invention is to provide a method of playing games, which the players of the game are able to remotely play the selected game while being able to play against one or more of other real players playing through the communication network in a real time manner.

Another advantage of the present invention is to provide a method of playing games, wherein the players are able to play the games anywhere anytime via remotely link the individual electronic devices to the communication network.

Another advantage of the present invention is to provide a method of playing games, wherein the player is able to set his or her own character and stay at the comfortable location to challenge the opponents in order to the adventure fantasy of the game.

Another advantage of the present invention is to provide a method of playing games, wherein the players are able to remotely play the game while communicatively chatting with other real players through the communication network.

Another advantage of the present invention is to provide a system of playing games, wherein the communication network of the casino is able to link to a plurality of individual electronic devices, such as slot machines, electronic roulettes, and electronic poker game, so that the players are able to remotely bet or play gambling game against another real player and/or the dealer, which may be the machine, via the individual electronic devices through the communication network. Therefore, the players have no need to physically go to the crowded gambling table of the table type games while being able to play against the real players.

Another advantage of the present invention is to provide a system of playing game, wherein the player is able to actuate the individual electronic device by inserting a membership card which may digitally store the player information and the prepaid money therein for actuating the games. Thereby, the system may also eliminate the precisely and accurately counting process of physical cash or betting chips after each round of the betting or wagering of the game, so as to enhance the security of the casino and players. Accordingly, the system will be designed primarily for the use of hotel guest. Gambling atmosphere will be fully provided for the hotel guest to play the game anywhere.

Another advantage of the present invention is to provide a system of playing game, wherein the information of the player, including credit card information and personal information, will be encrypted and stored, such tokenization, for enhancing the data security.

Additional advantages and features of the invention will become apparent from the description which follows, and may be realized by the following description of the instrumentalities and combinations particular pointing out in the appended claims.

According to the present invention, the foregoing and other objects and advantages are attained by providing a system of playing games, comprising:

a plurality of individual electronic devices for being activated by at least one player of the game to controllably and selectively play games therethrough; and

a networking system electrically linking to each of the individual electronic devices and being accessible by at least one casino for managing the system of playing games, wherein the communication network system comprises:

a communication network, which comprises an information storage for storing at least one of the player's information therein, and a plurality of game programs stored in the communication network; and

a remote connecting module for electrically linking the individual electronic devices with the communication network to form the networking system, so that when the player controllably activates the individual electronic device in an authorized manner to electrically link the communication network through the remote connecting module, the player is able to play the casino games in a remotely gambling manner.

The game players may activate the individual electronic devices via a membership card provided by the casino, so that when the membership card is electrically connected to the individual electronic device to authorize the player accessing the communication network of the casino, the player is able to selectively play the games for betting or wagering.

The communication network may further comprise an online chatting program electrically linking with the remote connecting module, so that the players are able to remotely play the games against or with other real players while being able to chat with other players in a real time manner. Therefore, the system of playing game does not require the players physically go to the gambling table, and meanwhile, provides the players remotely play against or with other real players in a real time manner.

The communication network may be wirely or wirelessly linked to the individual electronic device in the remote control manner. In other words, the individual electronic devices are able to access communication network remotely within a predetermined distance.

In accordance with another aspect of the invention, the present invention comprises a method for playing games, which comprises the steps of (a) providing a plurality of individual electronic devices for each of players of games playing game via each of the individual electronic devices; and (b) remotely linking the individual electronic devices to a networking system, wherein the networking system comprises a communication network having a remote connecting module to electrically connect the individual electronic devices with the networking system in a remotely connection manner, and a central control device for managing the networking system.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a flow chart of a method of playing games according to a preferred embodiment of the present invention.

FIG. 2 is a block diagram of a system of playing games according to the preferred embodiment of the present invention.

FIG. 3 is a perspective view of an electronic device according to the above preferred embodiment of the present invention.

### DETAILED DESCRIPTION OF THE PREFERRED EMBODIMENT

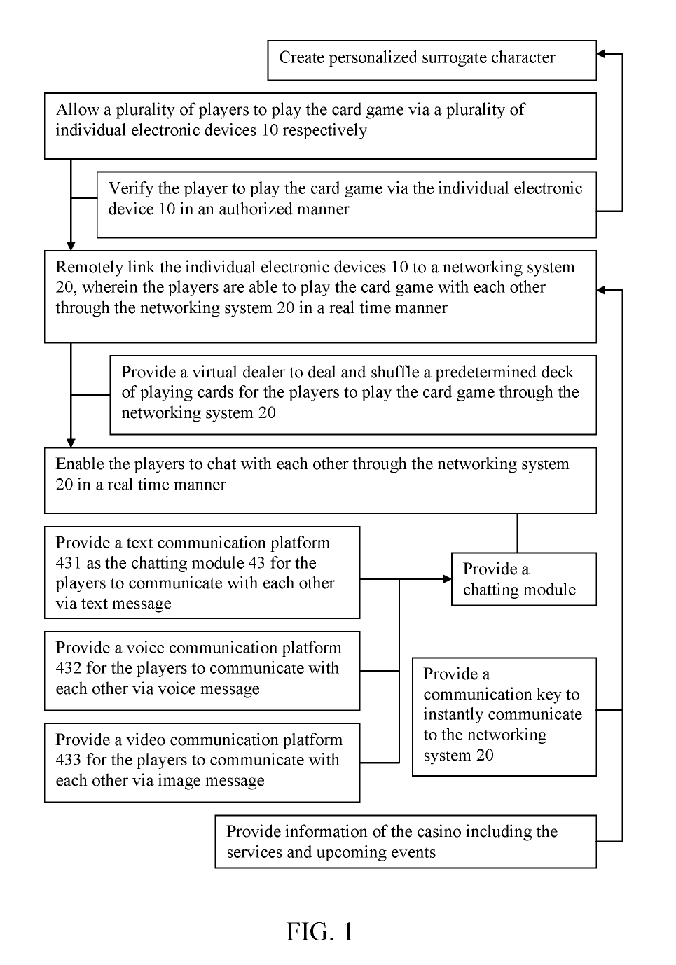

Referring to FIG. 1 of the drawing, a method of playing games, especially for card games, according to a preferred embodiment of the present invention is provided, wherein the method comprises the steps below.

(a) Allow a plurality of players to play the game via a plurality of individual electronic devices 10 respectively.

(b) Remotely link the individual electronic devices 10 to a networking system 20, wherein the players are able to play the game with each other through the networking system 20 in a real time manner.

(c) Enable the players to chat with each other through the networking system 20 in a real time manner, wherein the players are able to remotely and simultaneously play the game and chart with each other via the individual electronic devices 10 through the networking system 20, such that the networking system 20 forms not only a playing channel for the player to play the game but also a communication channel for the players to chat so as to enhance the entertainment of the game.

Accordingly, the networking system 20 may further comprise at least a central control 40 for centrally managing the networking system 20. The central control 40 preferably comprises an information storage module 41 for storing a plurality of information of players, and a plurality of game programs 42 electrically and digitally stored in the central control 40 for providing variety of games being remotely and virtually played by the players.

In other words, the networking system 20, which comprises the central control 40 remotely linked with the individual electronic devices 10 to form the virtual dealer to deal and shuffle a predetermined deck of playing cards for the players to play the game through the networking system 20. Accordingly, the players will play the game through the networking system 20 as if they are playing the real table game.

Therefore, the players are able to remotely connect the individual electronic device 10 to the remote connecting module 31 for communicatively accessing the communication network 30 and for playing the games that the communication network 30 provided in an authorized manner. The communication network 30 can be any networks, such as an computer network, International Mobile Telecommunication network, other private internal network, etc., so that through connecting to the designated communication network 30, the players are able to play the games in a remote playing manner.

The system preferably further comprises the chatting module 43 linked to the networking system 20 for enabling the players to chat with each other through the networking system 20 in a real time manner, wherein the networking system 20 forms not only a playing channel for the player to play the game but also a communication channel for the players to chat so as to enhance the entertainment of the game, such that the players are able to remotely and simultaneously play the game and chat with each other via the individual electronic devices 10 through the networking system 20. It is worth mentioning that the player is able to search other players through the chatting module 43. For example, the player is able to input the player name in the electronic device 10 for searching a particular player. Likewise, the player is able to search different players within a predetermined radial range of the electronic device 10. The player is able to set a private group for one or more designated players to join or a public group for any player to join.

Accordingly, the step (b) preferably further comprises a step of providing a virtual dealer to deal and shuffle a predetermined deck of playing cards for the players to play the game through the networking system 20.

The method may further comprise a step of activating the individual electronic devices 10 by the player to communicate between the player and the communication network 30, so that after the individual electronic device 10 is being activated by the player in the authorized manner, the player is able to monitor the selected game on a display of the individual electronic device 10 and to controllably interact with the game, such as entering a common or betting for gambling type games.

According to the preferred embodiment of the present invention, the central control 40 may further comprise a player verification module 44 for verifying the player to play the game via the individual electronic device 10 in the authorized manner, wherein each of the players is able to sign in the networking system 20 to participate the game and to sign out the networking system 20 to quit the game at any time.

Accordingly, the player verification module 44 can use the biometric technology, such as fingerprint, face recognition, hand geometry, iris recognition, to verify the person whether he or she is the authorized player. Preferably, a photo Id is used at the time when the player signs in and signs out the game while the date and playing time will be recorded.

Therefore, the step (a) may further comprise a step of verifying the player to play the game via the individual electronic device 10 in an authorized manner. Each of the players may be able to sign in the networking system 20 to participate the game and to sign out the networking system 20 to quit the game at any time, so as to activate the individual electronic devices 10 in the authorized manner.

Therefore, the networking system 20 is able to remotely connect two or more real players at the same time for the player competing or playing against other real players simultaneously over the communication network 30. It should be noted that through the networking system 20, the players have no need to physically go to a predetermined gathering location, such as in a gaming room, or a gaming table, while still being able to enjoy the fun and realistic of playing games with other real players.

Accordingly, the surrogate character can be created by the player that the surrogate character will be displayed during the play time. Therefore, other players will see the surrogate character instead of the actual image of the player. In addition, the username can also be created by the player such that the username will be displayed instead of the actual name of the player. Therefore, the player will be given a player ID and profiled photo ID during the game. Of course, the player must use his or her truth person information to register and sign in the central control 40 in order to play the game.

A character development module 434 will be provided for the players to create their personalized surrogate character, wherein a plurality of fantastic computerized characters will be provided for the players to select in order to enhance the entertainment and gambling experience.

The central control 40 may further comprises a chatting program of the chatting module 43 stored thereat, so that when two or more players are linked to the communication network 30 of the networking system 20 via each of the individual electronic devices 10, the players are further being able to chat and talk to each other while playing the games over the communication network 30. Therefore, the reality of the virtual games is further enhanced.

The step (c) of the method may further comprise a step of providing a text communication platform 431 as the chatting module 43 for the players to communicate with each other via text message through the individual electronic device 10 so as to allow the player to exchange written message with each other during playing the games.

In order to enhance the reality of chatting with other players, the step (c) may further comprise a step of providing a voice communication platform 432 for the players to communicate with each other via voice message through the individual electronic device 10, so as to allow the player to talk to each other during the game.

Accordingly, the step (c) may also comprise a step of providing a video communication platform 433 for the players to communicate with each other via image message through the individual electronic device 10 so as to allow the player to view each other during the game and to further enhance the reality as of playing the game face-to-face with other players and/or dealers in the real time manner.

Therefore, the chatting module 43 preferably comprises the text communication platform 431, the voice communication platform 432, and the video communication platform 433 optimizes the reality of playing games without physically showing up at the predetermined location, so that the user has relatively more freedom to play the games anywhere anytime.

A step of posting a record of competence in the game for each of the players at the respective individual electronic device 10 is preferably provided. The record contains winning/losing records and tax information of each of said players in response to said winning/losing records. For example, the remains or totally amount of the cash or gambling chips of each of the players at the same game may be showed on the display screen of each of the individual electronic devices 10.

Accordingly, in the entertainment industrial, there are plenty of casinos or gambling rooms have the gambling type games provided for the players playing the game for betting against each other or wagering against the dealer. However, during the peak of gambling, all the table type games in the casino may be full of the players or tourists, so that the casino may face the shortage of game tables or the shortage of dealers. Therefore, the players in the casino may leave no choose but instead going to play the machine type gambling games. However, the machine type gambling games in the casino, such as slot machines, or roulette gambling machines, does not have the function to allow the players to gamble against another real player.

Therefore, the communication network 30 is further embodied as a local or private casino communication network 30 for electrically connecting two or more individual electronic devices 10 of one or more casino's customers, so that the players of the casino customer are able to remotely link to the communication network 30 for playing the games remotely through the individual electronic devices 10. Thus, the players are able to gamble anywhere anytime that he or she is able to connect to the casino communication network 30. In other words, the players not only have their own privacy to play the game at their own desired locations but also have communication and interaction, sociability among other players. Preferably, the electronic device 10 comprises a GPS unit for identifying the location of the electronic device 10. Once the electronic device 10 is out of the casino area or is out of the range of the private casino communication network 30, the electronic device 10 will be disabled.

For instance, the players may be able to connect the individual electronic devices 10 to the casino communication network 30 while staying in the hotel of the casino, so that the players are able to play the Casino War games to wager against the virtual dealer of game program 42 installed in the central control 40 via plugging into a communication plug provided in a hotel room to wirely connect to the casino communication network 30 or wirelessly link to the casino communication network 30 with a provided password. Therefore, the players are able to remotely gamble via playing the virtual games over the communication network 30 against other real players in a real time manner.

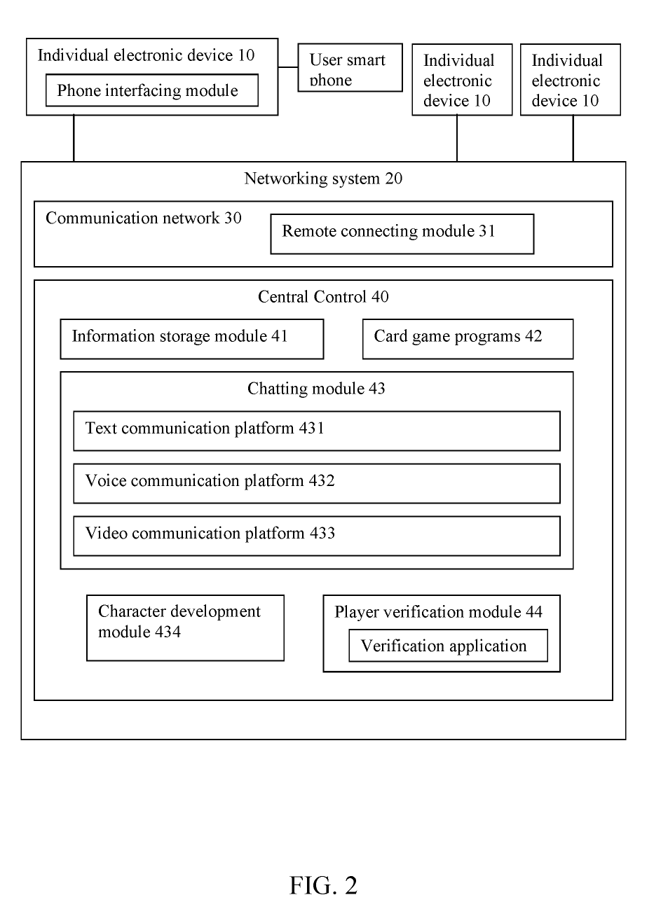

Referring to FIG. 2 of the drawings, the present invention further provides a system for playing games through the networking system 20, wherein the system comprises the plurality of individual electronic devices 10 and the networking system 20, wherein the networking system 20 preferably comprises the communication network 30 and the central control 40 as mentioned above.

The individual devices 10 can be a personal computer, a portable personal device, or any other electronic devices which is able to link to the networking system 20 wirely or wirelessly in the remotely connection manner. Preferably, the individual electronic devices 10 are further embodied as a plurality of game consoles provided in the casino or the like, so that the gamblers are able to use the portable gaming device to remotely joint the networking system 20 for selectively monitoring and interacting with the games displayed on the game console of the individual electronic devices 10 with other real gamblers in the real time manner.

It is worth to mention that the casino players are able to select variety games provided in one single game console, so that there is no need for players physically going to each of the gambling table for different types of games. Also, the players do not have to joint the crowded gaming tables of the games while being able to enjoy playing with other players, to socialize with other players, and enjoy the entertaining environment in the casino.

The game console in the casino remotely linked to the networking system 20 to communicate with the central control 40 is also programmed that the game console is able to automatically count the winning or losing of each round of the game, so that the players may be able to collect the credit of winning or losing and cash the credit after the finishing the games. Therefore, the game consoles are able to enhance the safety of the players by eliminating the need of carrying large amount of chips or cash, and solve the problem of the dealer shortage in casino.

In the preferred embodiment of the present invention, the method for playing games may further comprise a step of providing a plurality of the game console as the individual electronic devices 10, so that the players of the casino customers are able to enjoy the games simply via the display of the game console to bet, monitor the game, and to remotely play with other real players who's being automatically arranged to the same virtual game room of the game via the central control 40. Therefore, the players are able to stay in the same seat for selectively playing the games without moving around to different gaming tables of the games. Accordingly, casino will increase value of clients without having to expand casino facility size. By saving construction cost, casino will be able to develop better services and to maintain high level entertainment quality.

As mentioned above, the system may further comprise the chatting module 43 electrically stored in the central control 40, so that the players are able to play against the other players remotely connected to the networking system 20 while talking and chatting with each other, so as to enhance the reality as of playing in a real gaming table of game. In other words, the player, who is the casino resort quest, can play game any time anywhere even he or she is not presently stay in the casino resort.

The information storage module 41 of the central control 40 may store a plurality of personal information of the players, such as the phone numbers, names, mail and email addresses, passwords, and/or any activity records regarding the playing of the games, such as winning or losing thereof, and any other activities in casino. The information storage module 41 may further digitally store the cash flow information of the players, such that the players are able to directly bet against the virtual dealer of the networking system 20 and to deduct or add the amount of the cash stored in the information storage module 41 in responsive to the winning or losing of the games.

Accordingly, the information storage module 41 will store the surrogate character created by each of the players. In addition, the information storage module 41 will also store the tax information of each of the players. When the player plays each game, the gambling tax will be determined when the player wins the game. In other words, when the player logs out the game, the gambling tax will be determined and recorded in responsive to the gambling winning or losing. The gambling tax will be accumulated for a time period, such as yearly, wherein a gambling tax statement will be printed and sent to each player for tax purpose.

The communication network 30 of the system is preferably embodied as private casino communication network 30 provided for the players of the casino customers accessibly link with the communication network 30 in the authorized manner for entertaining the customers thereof. The game consoles are electrically and remotely linking to the casino communication network 30 to form the networking system 20 for remotely playing games through the game console or any other individual electronic devices 10 in the real time manner.

The individual electronic devices 10 in the preferred embodiment of the system, such as personal computer, may be able to activated in the hotel room of the casino wirely or wirelessly as mentioned above, so that the players of the casino customers are able to simply relax in their own rooms without physically coming out to the main gambling area of the casino, so as to further provide another way to enjoy gambling and playing games in the casino.

According to the preferred embodiment of the present invention, the players are able to remotely link to the individual electronic devices 10 to the casino communication network 30 through the remote connecting module 31 thereof, wherein casino may provide a membership card or the like to each of individual players of casino customers, wherein the membership card may have the corresponding personal information of the customer therein, so that when the membership card is being inserted into the individual electronic devices 10, such as the game console, the communication network 30 is linking the individual device 10 to the information storage module 41 of the central control 40, so that after confirming the players information by matching with the stored information in the information storage module 41 to authorize the activation requires from the player, the central control 40 will automatically and remotely activate the individual electronic device 10 to remotely link to the networking system 20. Preferably, the photo ID is required to sign off to the individual electronic device 10 with date and time recorded. Therefore, the individual storage module 41 is able to link to the individual electronic devices 10 for posting the record of the competence in the game for each of the players at the respective individual electronic device 10.

Alternatively, the individual electronic device 10 may be activated by providing a predetermined account and corresponding passwords thereof, so that the players are able to enter the passwords to submit to the central control 40 for being authorized to activate the individual electronic device 10.

Alternatively, the individual electronic device 10 can also be activated by inserting a financial card, such as credit card, debit card, or the likes, so that casino communication network 30 may directly and players to the central control 40 for accessing the game programs 41 to remotely play the games through the individual electronic devices 10 and to automatically deduct all charges from playing the games directly from player's final card.

It should be noted that the membership card can also integrate with the room card key of the casino hotel, so that the casino can easily charge the fee of the entertainment of playing game through the room payment account of the players. The membership card can have variety of shapes, such as traditional flat rectangular shaped magnetic card or IC card, or chips shaped having magnetic sensor therein for electrically communicating with the individual electronic devices 10, in such a manner that the players are able to conveniently activate the individual electronic devices 10 and saving or transferring a predetermined amount of cash or credit therein without carrying around actual casino gambling chips or cash. The casino is able to securely manage the authorization of the players to enhance the security of casino. The information of the player, including credit card information and personal information, will be encrypted and stored, such tokenization, for enhancing the data security.

Therefore, the method of playing games may further comprise a step of authorizing the remotely submitted activation requests by the players via each of the individual electronic devices 10. Accordingly, the players are able to securely activate the individual electronic device 10 for linking with the communication network 30, such as the private casino communication network 30 via the remote connecting module 31, so as to enhance the safety of the players and the casino. The authorizing of the activation requests of the player may be performed via providing the membership card, or any of the above mentioned methods to accomplish the authority of the player via the individual electronic device 10.

It is worth mentioning that the electronic device 10, i.e. the portable game console, is provided in every guest room as standard casino equipment ready to be utilized by the hotel guests of that particular room. For example, the same credit card of the user for the hotel will link to electronic device 10 for security purpose so as to provide the casino guests the correct financial statement. Criminals will be less likely to stay overnight. It is also important to mention GPS is in every electronic device 10. This is why GPS is so important to the collective operation of the present invention. Another safety feature that is link with the GPS is that the electronic device 10 will stop all operations when the electronic device 10 is located outside it's predetermine intranet working area. It is also worth mentioning when the electronic device 10 is back in its working territory the electronic device 10 will not return to operational capacity. The electronic device 10 must be return to the casino for evaluation and maintenance for restart-up.

As will be readily appreciated by one skilled in the art, the system of playing game preferably further comprises a private casino communication networking platform for remotely linking with the individual electronic devices 10 in the authorized manner and for providing an interface for the player managing their private account information and selectively controlling and monitoring the games through the individual electronic devices 10.

Accordingly, the step (b) of the method of playing games may further comprises a step of providing the private casino communication networking platform for remotely linking the communication network 30 with the individual electronic devices 10 and providing the game interface for the players to interact with games and other registered players of the networking system 20. It is worth to mention that the central control 40 may further electrically link to any other facilities or services system attached to the casino, so that the players of the casino customers are able to link to the interface of the casino communication networking platform for selectively and remotely placing an order, such as ordering room services, or reserve the restaurant reservation.

Accordingly, each of the individual electronic devices 10 further comprises a communication key to instantly communicate to the networking system 20. For example, the communication key can be a service request button arranged in such a manner that when the service request button is pressed, the operator of the central control 40 will be notified to provide high quality service to the player. Therefore, even the player stays at the hotel room or sits in front of the individual electronic device 10 in the casino, the player will get the service immediately. The communication key can also be a panic button arranged in such a manner that the operator of the central control 40 will be notified in case of emergency. For example, when other players are cheating during the game, the player is able to notify the operator immediately. Or when the players are in dangerous, such as some one breaking in his house, the operator of the central control 40 will be notified immediately.

The step (a) of the method may further comprise a step of providing a plurality of game console in the casino as the individual electronic devices 10, so that the casino is able to provide the players of their customers another way to enjoy playing games or gambling as mentioned above.

The method of the present invention further comprises a step of providing information of the casino including the services and upcoming events such as game competition, room and restaurant reservation, casino schedule, and promotion.

The present invention describes a complicated system of communication, which includes texting, audio, video and photos in combination or selective modes without interfering in the flow of the game, among all and any hotel guest. There is an external component for surrounding people not playing with the user and there is an internal component for players playing with the user in the device.

In the external component are 1) general and surrounding personal surrogate greeting, 2) personal profile, 3) filter profile system, 4) save match, 5) line of sight, 6) save profile 7) on and off system of communication of any or all external components. It is important to note that in the external component you can only save match and save profile information of other surrounding players but only in the internal component the user can communicate live. In save match mode the computer will tell you when that particular person is able to play with you and in save match mode the user can put a numerical priority pending the other player availability. It is important to note the general personal profile can be of the same nature with the personal profile or they can be totally different. In the save profile the line of sight and general profiles will be save. To be review now or later with save profile, one must ask permission to the general profile or the line of sight profile to play together (which is different from save match). And the pictures/photos can be real or of a fantasy in nature.

In the internal components user will select from novice, knowledgeable, skillful, and expert. These modes select the time function for all texting, pictures, videos, and audio during game time. It is important to note the user can have his picture displayed or the surrogate picture in the game to represent his physical table location in the game. It is important to note during the game only the payers will see each other selection of communication and all the pictures of the other players in the table. Some may want only audio while other may only want pictures and text. And it is in this window where each other past statistical analysis for this game will be recorded and up dated no matter what mode the user in, for future reference.

It is important to note when playing in the skillful or expert mode players can designate the table limits over 100 dollars and when two or more players what to share each others general profile or personal profile and still play, they must request each others approval to change game to novice or knowledgeable this will aloud for better flow of the game.

The device will only save players that have both accepted to be saved, and in the future if any of those players are in the same casino it will automatically informed the user and save match will let the user prioritize any preference of payers.

According to the preferred embodiment, the system of the present invention can be modified to be used and customized for a facility such as hotel casino, amusement park, university, resort, convention center, cruise, and the like.

The electronic device 10, i.e. the portable electronic device, is provided by the facility for the users to individually access respectively, wherein each of the electronic devices 10 comprises a plurality of different applications preloaded therein, a positioning unit such as a GPS unit and a phone connection station 11 for connecting with an identification means. According to the preferred embodiment of the present invention, the identification mans is embodied as a user smart phone of the user.

The present invention further provides a method of communicatively linking a electronic devices 10, which comprises the following steps executed by a computing system.

(1) Remotely link the electronic devices 10 in a closed communication network, wherein the electronic devices 10 and the closed communication network are provided by the facility.

(2) Verify each user for the electronic device 10 in an authorized manner in order to activate the electronic device by connecting a user smart phone of the user to the electronic device 10.

(3) Restrict each user to remotely access the electronic device 10 in limited locations within an area of the facility via the GPS unit built-in with the electronic device 10 and within a range of the closed communication network.

(4) Connect the electronic devices 10 with each other through the closed networking system that allows the user to selectively communicate with each other and to selectively execute different applications preloaded in the electronic device 10 through the closed networking system in a real time manner.

According to the preferred embodiment, the electronic device 10 is arranged for connecting to the user smart phone. The electronic device 10 can be connected to the user smart phone wirelessly or by wire. Accordingly, through the connection between the electronic device 10 and the user smart phone, the record of the competence is sent to the user smart phone when it is authorized by the user. The electronic device 10 is wirelessly connected to the user smart phone by means of “Bluetooth”, “NFC”, or the closed communication network. It is worth mentioning that when the electronic device 10 is connected to the user smart phone by wire, the user smart phone is also charged by the electronic device 10, so as to prevent the user smart phone out of battery. For wireless connection, the phone connection station 11 can be a wireless connection module having a predetermined connection range, such as 10 feet, of the electronic device 10, wherein the user smart phone should be located within the connection range of the electronic device 10. When the user smart phone is out of the connection range, the electronic device 10 will disconnect with the user smart phone.

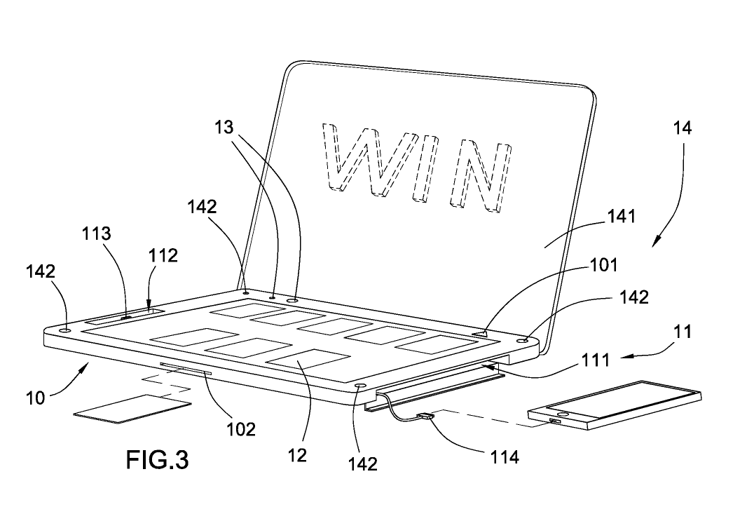

As shown in FIG. 3, the phone connection station 11 is arranged for holding the user smart phone in position. The phone connection station 11 can be a storage cavity 111 that the user smart phone can be received therein. Once the user smart phone is stored in the storage cavity 111, the electronic device 10 can be connected to the user smart phone wirelessly or by wire. In one embodiment, the user smart phone is received in the storage cavity 111 of the phone connection station 11 and is connected to the electronic device 10 via a connection cable 114 extended from the storage cavity 111. Therefore, the user smart phone is charged by the electronic device 10. In other words, the connection cable 114 is connected to the user smart phone for charging the user smart phone and for activating the electronic device 10. The electronic device 10 is disconnected and deactivated when the connection cable 114 is disconnected to the user smart phone.

Accordingly, each of the electronic device 10 further comprises a phone interfacing module for screen-imaging the user smart phone on the electronic device 10. When the electronic device 10 can be connected to the user smart phone, the display screen of the electronic device 10 will interface with the user smart phone. For example, the display screen 12 of the electronic device 10 will image the screen of the user smart phone, such that the information displayed on the screen of the user smart phone will be displayed on the display screen 12 of the electronic device 10. Even though the user smart phone is received in the storage cavity 111 of the phone connection station 11, the user is able to view what information to be displayed on the user smart phone through the electronic device 10 without removing the user smart phone from the electronic device 10. It is worth mentioning that the electronic device 10 cannot obtain or share any personal data from the user smart phone, such that no phone data will be transferred or stored in the electronic device 10 when it is connected to the electronic device. In addition, the player cannot operate the user smart phone through the electronic device 10.

It is worth mentioning that the phone connection station 11 can be a docking station 112 for securely holding the user smart phone in position. For example, the bottom portion of the user smart phone is held at the docking station 112, wherein a terminal 113 is provided at the docking station, such that when the user smart phone is docked at the docking station 112, the terminal 113 is connected to the user smart phone to connect with the electronic device 10. Therefore, the user smart phone is charged by the electronic device 10. In other words, the terminal 113 is connected to the user smart phone for charging the user smart phone and for activating the electronic device 10. The electronic device 10 is disconnected and deactivated when the terminal 113 is disconnected to the user smart phone.

Accordingly, the electronic device 10 is activated by an identification card, such as a membership card, issued by the facility by inserting the identification card into a card reader slot 102 of the electronic device 10. In one embodiment, the closed communication network is a private casino communication network provided by the casino, such that the electronic devices 10 are connected with each other through the private casino communication network. The identification card can also be the casino room card, such that the electronic device 10 is activated by the casino room card. In addition, the electronic device 10 can also be activated by the user smart phone. The verification module 44 further comprises a verification application arranged for being downloaded to the user smart phone, such that when the verification application is executed by the user smart phone, the electronic device 10 is automatically activated. The user is able to input the user′ name and hotel room number, as an example, after the verification application is executed by the user smart phone. Then, the verification module 44 will verify the user when the user smart phone is linked to the networking system 20 through the mobile communication network or private casino network. For example, the verification application will generate a verification code at the user smart phone, such that when the verification code is sent to the verification module 44 by the electronic device 10 through the private casino communication network for verification, the electronic device 10 will be automatically activated. Likewise, the user is able to input the verification code in the electronic device 10 for activation. It is worth mentioning that since the electronic device 10 is connected to the user smart phone, the verification code can be directly sent by the electronic device 10 to the verification module 44 through the private casino communication network for activation. Once the user smart phone is disconnected from the electronic device 10, the electronic device 10 will be automatically deactivated and locked. Therefore, the player requires re-activation of the electronic device 10 by the room card and/or the user smart phone.

The electronic device 10 further comprises a connection indicator 13 generating a connection signal for indicating a connection between the electronic device 10 and the user smart phone. In one embodiment, the connection indicator 13 comprises a light indicator and/or audio indicator provided on the electronic device 10, wherein the light indicator is on for generating a light signal, such as a green light, and/or the audio indicator generates an “On” sound signal, such as a beep sound, when there is the connection between the electronic device 10 and the user smart phone. Therefore, the player is notified that the user smart phone is received in the storage cavity 111 of the phone connection station 11. In other words, the connection indicator 13 will generate the notifying signal that also indicates the presence of the user smart phone in the phone connection station 11.

When the electronic device 10 is disconnected from the user smart phone, the light indicator will be off and the audio indicator will generate an “Off” sound signal, such as two beep sounds. In other words, once the user smart phone is removed in the storage cavity 111 of the phone connection station 11 by unplugging the connection cable, the light indicator will be off and the audio indicator will generate the “Off” sound signal.

The applications are different amenities applications preloaded in the electronic device 10, wherein the users are able to acquire different services provided by the facility via the amenities applications. In one example, the amusement park will the electronic device 10 with different amenities applications for different entertainment attractions, rides, and other events. The user is able to selectively execute the amenities applications to reserve a timed ticket for the rides, such that the user is able to spend time elsewhere instead of waiting in line for the rides and events. The user is able to selectively execute the amenities applications to make a table reservation of a restaurant in the amusement park and even able to view the menu and to pre-order food from the restaurant in advance. Through the GPS unit, the user is able to view the map in the amusement park and the user location therewithin to guide the user to go from place to place. The parent user is able to track the location of child in the facility via the GPS unit. In addition, different game applications can also preloaded in the electronic device 10, such that the user is able to play the game by the electronic device 10, especially during the wait time or spare time. Parental controls can be set in the electronic device 10 by the parents users that sets controls for the use of the electronic device 10 by their children.

In other embodiment, the casino will provide the electronic devices 10 for the users, wherein the applications are different game applications and different amenities applications preloaded in the electronic device 10. Each of the game applications is executed in the electronic device 10 for the users playing casino games with each other or against a virtual dealer through the private casino communication network in a real time manner. Each of the amenities applications is executed in the electronic device 10 for the users acquiring different services provided by the casino. For example, the user is able to selectively execute the amenities applications to make a table reservation of a restaurant in the casino. The user is able to set the room configuration in advance, such as switching on the air conditioning system or selectively adjusting the light intensity of the room light before the user enters into the hotel room. It is worth mentioning that since the applications are preloaded in the electronic device 10 and cannot be deleted in the electronic device 10 by the user, the user cannot download these applications into the user smart phone. When the user checks out the hotel casino, the corresponding electronic device 10 will be returned back to the hotel casino. The user verification information will be erased in the electronic device 10, such as deactivated by the user smart phone and/or factory reset by the casino, the user will no longer able to control the room configuration or play the casino game by the user smart phone.

The software operation system and firmware of the electronic device 10 is automatically updated by the facility. In one embodiment, the casino will update the hardware and software of the electronic devices 10. For example, the casino will update the game applications and the amenities applications in the electronic devices 10, such that any new game or new amenities will be updated for the users.

The game application can be configured by the user to set the game expense through an option setting of “playing budget”. For example, the user is able set $1000 as the limitation option for playing the casino games through the electronic device 10. When the user loses close the limitation, the electronic device 10 will notify the user, such as through the light indicator and/or audio indicator. It is an option for the user to stop playing the game when exceeding the limitation unless the limitation option is disabled by the user.

As shown in FIG. 3, the electronic device 10 further comprises a graphical display 14 for the user to play games. The graphical display 14 comprises a display panel 141 foldably coupled on the electronic device 10 and an image projector 142 provided on the electronic device 10 for projecting an image on the display panel 141. Preferably, the image projector 142 is a 3D hologram projector for holograph generation on the display panel 141. It is worth mentioning that the display screen 12 of the electronic device 10 is a touch screen that the user is able to play any game on the display screen 12. Therefore, the electronic device 10 will provide a holographic display when the user plays the game and/or chat with other users through the electronic device 10. It is an option that the game would be projected on the display panel 141 in a 3D holographic manner so as to enhance the excitement of the game. For example, when playing a card game, the cards can be digitally displayed on both of the display screen 12 and the display panel 141. For privacy purpose, the user is able to select the cards to be displayed on the display screen 12 only. Other displays, such as text messages, game result, and/or other users' surrogate characters, can be displayed on the display panel 141. For example, when the user wins the card game, a message of “win” will be displayed on the display panel 141. It is worth mentioning that the message displayed on the display panel 141 is the holography.

Through the chatting module 43, the users are able to chat with each other as a group or individually via the electronic devices 10 through the closed communication network. It is worth mentioning that the user may select his or her status as available or not, such that the user is able accept or reject any chatting request from other users.

As it is mentioned above, the information storage module 41, which is executed by the computer, linked to said portable electronic devices for posting a record of competence in the game for each of the users at the respective electronic device 10 and for transferring the record of competence to the user smart phone, wherein the record contains winning/losing records and tax information of each of the users in response to said winning/losing records. Each of the electronic devices 10 has the panic button 101 for being activated by the user to notify the facility in case of emergency. It is worth mentioning that the facility can have authorization to open the closed communication network to release the restriction of the access of the electronic devices 10, such that the users are able to access the electronic devices 10 through any public communication network. In one embodiment, university will allow the students to access the electronic devices 10 through the public communication to access the library, bookstore, and/or classroom information in the university. In addition, the electronic devices 10 can be sold or rent by the facility to the users.

It is worth mentioning that the electronic device 10 of the present invention not only serves as a portable game console for the user to play game but also serves as a conference tablet for conference meeting in the casino. Accordingly, the information and/or keynote of the conference meeting will be automatically saved in the electronic device 10. For example, the conference note will be downloaded in the electronic device 10. The recorded speaker video will be downloaded in the electronic device 10. The text messages, voice messages, video messages, and/or other interacting messages for people will be saved in the electronic device 10. It is worth mentioning that the above information of the conference meeting can also be stored in the “Cloud” storage, such that after the electronic device 10 is returned back to the hotel casino, the user is able to recall all the information by login in the “Cloud” storage.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method of communicatively linking a plurality of portable electronic devices via a plurality of users, comprising the steps executed within a facility with a closed communication network of:
(a) remotely linking said portable electronic devices in said closed communication network, wherein said portable electronic devices and said closed communication network are provided by said facility;
(b) verifying each user for said portable electronic device in an authorized manner in order to activate said portable electronic device by connecting an identification means including at least a user smart phone of said user to said portable electronic device;
(c) restricting each user to remotely access said portable electronic device in limited locations within an area of said facility via a positioning unit built-in with said portable electronic device and within a range of said closed communication network; and
(d) connecting said portable electronic devices with each other through said closed networking system that allows said user to selectively communicate with each other and to selectively execute different applications preloaded in said portable electronic device through said closed communication network in a real time manner.

2. The method, as recited in claim 1, wherein said step (b) further comprises the steps of:
(b.1) generating a verification code by said identification means via a verification application therein; and
(b.2) verifying said verification code in said identification means by inputting said verification code in said identification means.

3. The method, as recited in claim 2, wherein said portable electronic device is deactivated when said portable electronic device is disconnected with said identification means.

4. The method, as recited in claim 3, wherein said user smart phone is received in a phone connection station of said portable electronic device and is connected to said portable electronic device via a connection cable.

5. The method, as recited in claim 3, wherein said identification means is wirelessly connected to said portable electronic device.

6. The method, as recited in claim 1, wherein said identification means further includes a membership card issued by said facility to said user, and the step (b) further comprises a step of further verifying each user for said portable electronic device in an authorized manner by said membership card issued by said facility.

7. The method, as recited in claim 1, further comprising a step of interfacing said identification means with said portable electronic device for screen-imaging the user smart phone on said portable electronic device.

8. The method as recited in claim 1 wherein, in said step (d), said applications are different amenities applications preloaded in said portable electronic device, wherein said users are able to acquire different services provided by said facility via said amenities applications, wherein each of said portable electronic devices has a panic button for being activated by said user to notify said facility in case of emergency.

9. The method, as recited in claim 1, wherein said closed communication network is a private communication network internally provided by said facility, such that said portable electronic devices are connected with each other through said private communication network.

10. The method, as recited in claim 9, wherein the step (b) further comprises a step of verifying each user for said portable electronic device in an authorized manner by a casino room card when said facility is a casino.

11. The method as recited in claim 9 wherein, in said step (d), said applications are different game applications preloaded in said portable electronic device by said facility that is a casino, such that said users are able to play casino games with each other or against a virtual dealer through said private communication network in a real time manner.

12. The method, as recited in claim 11, wherein said step (d) further comprises a step of generating a holographic display via a graphical display when the player plays the game, wherein said graphical display comprises a display panel foldably coupled on said portable electronic device and an image projector provided on said portable electronic device for projecting an image on said display panel in a holographic manner.

13. The method, as recited in claim 12, further comprising a step of posting a record of competence in said game for each of said players at said respective portable electronic device and transferring said record of competence to said user smart phone, wherein said record contains winning/losing records and tax information of each of said players in response to said winning/losing records.

14. A system for users within a facility, comprising:
a plurality of portable electronic devices provided by the facility for the users to individually access respectively, wherein each of said portable electronic devices comprises a plurality of different applications preloaded therein, a positioning unit, and a phone connection station for connecting with a user smart phone of said user;
a private networking system, which is a closed communication network being executed by a computer, wherein said portable electronic devices are communicated linked with each other through said closed communication network, wherein said portable electronic devices are restricted for being accessed in limited locations within a facility area in a real time manner via said positioning units of said portable electronic devices;
a verification module, which is executed by said computer, for verifying said user to access said portable electronic device in an authorized manner, wherein said verification module comprises a verification application arranged for being executed by said user smart phone to generate a verification code, wherein said verification code is input into and sent by said portable electronic device to said verification module through said closed communication network in order to activate said portable electronic device; and
a chatting module which is executed by a computing system, comprising a communication platform that links said portable electronic devices to said private networking system for enabling said users to chat with each other by said portable electronic devices through said closed communication network in a real time manner.

15. The system, as recited in claim 14, wherein said facility is a casino and said closed communication network is a private casino communication network provided by said casino, such that said portable electronic devices are connected with each other through said private casino communication network.

16. The system, as recited in claim 15, wherein said applications are different game applications and different amenities applications preloaded in said portable electronic device, wherein each of said game applications is executed in said portable electronic device for said users playing casino games with each other or against a virtual dealer through said private casino communication network in a real time manner, wherein each of said amenities applications is executed in said portable electronic device for said users acquiring different services provided by said casino.

17. The system, as recited in claim 15, wherein each of said portable electronic devices is also activated by a casino room card of said user provided by said casino.

18. The system, as recited in claim 15, further comprising an information storage module, which is executed by said computer, linked to said portable electronic devices for posting a record of competence in said game for each of said users at said respective portable electronic device and for transferring said record of competence to said user smart phone, wherein said record contains winning/losing records and tax information of each of said users in response to said winning/losing records.

19. The system, as recited in claim 15, wherein each of said portable electronic devices further comprises a phone interfacing module executed by said portable electronic device for screen-imaging said user smart phone on said portable electronic device.

20. The system, as recited in claim 15, wherein each of said portable electronic devices further comprises a graphical display which comprises a display panel foldably coupled on said portable electronic device and an image projector provided on said portable electronic device for projecting an image on said display panel in a holographic manner.
